(19) United States
(12) Patent Application Publication
(10) Pub. No.: US 2011/0270420 A1
(43) Pub. Date: Nov. 3, 2011

(54) MOTION CONTROL ENHANCED RADIO FREQUENCY CONTROL SYSTEM AND METHOD

(76) Inventors: Kent Tabor, Pewaukee, WI (US); Kiet Pham, Pewaukee, WI (US)

(21) Appl. No.: 13/082,776

(22) Filed: Apr. 8, 2011

Related U.S. Application Data
(60) Provisional application No. 61/322,591, filed on Apr. 9, 2010.

(51) Int. Cl. G05B 11/01

(52) U.S. Cl. 700/14; 700/12

(57) ABSTRACT

A system includes a first light assembly including a first light, a first motion sensor, and a first transceiver. A second light assembly includes a second light, a second motion sensor, and a second transceiver, the second light assembly positioned a first distance from the first light assembly. A third light assembly includes a third light, a third motion sensor, and a third transceiver. The third light assembly is positioned a second distance from the first light assembly, the second distance being greater than the first distance. The first light is transitioned to an on condition and the first transceiver broadcasts a signal in response to the first motion detector detecting motion, and the second transceiver receives the signal and activates the second light in response to the signal and the third transceiver does not receive the signal.

### RELATED APPLICATION DATA

This application claims priority to U.S. Provisional Patent Application No. 61/322,591 filed Apr. 9, 2010.

### BACKGROUND

The present invention relates to motion controlled systems, and more particularly to motion controlled systems enhanced by a radio frequency control.

Motion controlled systems are often used to detect motion and take a control action based on that motion. However, motion control detectors have limited range. Enhancements to the range of a motion detector can adversely affect the sensitivity and creating multiple false indications of motion.

### SUMMARY

In one construction, the invention provides a system that uses motion control in combination with an RF transceiver to operate devices across a larger area than would be possible using motion detection alone. The system includes a number of components with each component having associated therewith a motion detector and an RF transceiver. Detection of motion by a motion detector results in activation of the associated device and the transmission of a signal form the associated transceiver. The devices associated with any transceiver that receives the signal is also actuated in response to the detected motion.

In one construction, the invention provides a system that includes a plurality of electrical components arranged in an array to cover a system area. Each of the electrical components is spaced apart from each of the remaining electrical components and is operable in a first state and a second state. A plurality of motion sensors are each positioned adjacent one of the electrical components and are operable to detect motion within a device area. The device areas cooperate to cover at least the system area. A plurality of transceivers are each positioned adjacent one of the electrical components and are operable to receive a signal from a first portion of the plurality of transceivers and to transmit a signal to a second portion of the plurality of transceivers. Each motion sensor transitions its corresponding electrical component to the second state and activates its corresponding transceiver to transmit a signal in response to the detection of motion within its device area, and each transceiver transitions its corresponding electrical component to the second state in response to the receipt of the signal.

In another construction, the invention provides a method of transitioning select electrical components from a plurality of electrical components in a system area from an off state to an on state. The method includes positioning a motion sensor adjacent each of the plurality of electrical components, each motion sensor operable to detect motion within a device area. The method also includes positioning a transceiver adjacent each of the plurality of electrical components and motion sensors, each transceiver operable to receive a signal from a portion of the transceivers and to transmit a signal to a portion of the transceivers. The method further includes detecting motion within the device area of a first of the motion sensors, transitioning a first of the plurality of electrical component associated with the first motion sensor to the on state in response to the detected motion, and broadcasting a signal from a first transceiver associated with the first motion sensor. The method further includes receiving the signal at a second of the plurality of transceivers, the second transceiver spaced a first distance from the first transceiver, and transitioning a second electrical component associated with the second transceiver to the on state in response to receipt of the broadcast signal.

In yet another construction, the invention provides a method of operating a plurality of light assemblies to illuminate a system area. Each of the light assemblies includes a light, a timer, a motion detector, and a transceiver. The method includes positioning a first light assembly in the system area, the first light assembly including a first light, a first timer, a first motion detector, and a first transceiver. The method also includes positioning a second light assembly in the system area, the second light assembly spaced a first distance from the first light assembly and including a second light, a second timer, a second motion detector, and a second transceiver. The method further includes positioning a third light assembly in the system area, the third light assembly spaced a second distance from the first light assembly, the second distance being greater than the first distance, the third light assembly including a third light, a third timer, a third motion detector, and a third transceiver. The method also includes detecting motion with the first motion detector, energizing the first light in response to the detection of motion, and broadcasting a signal at a predetermined strength in response to the detection of motion. The strength selected such that the signal can be detected by a transceiver spaced the first distance from the first light assembly and cannot be detected by a transceiver spaced a distance greater than the first distance from the first light assembly. The method further includes receiving the signal at the second transceiver and energizing the second light in response to the receipt of the first signal.

In another construction, the invention provides a system that includes a first light assembly including a first light, a first motion sensor, and a first transceiver. A second light assembly includes a second light, a second motion sensor, and a second transceiver, the second light assembly positioned a first distance from the first light assembly. A third light assembly includes a third light, a third motion sensor, and a third transceiver. The third light assembly is positioned a second distance from the first light assembly, the second distance being greater than the first distance. The first light is transitioned to an on condition and the first transceiver broadcasts a signal in response to the first motion detector detecting motion, and the second transceiver receives the signal and activates the second light in response to the signal and the third transceiver does not receive the signal.

Other aspects of the invention will become apparent by consideration of the detailed description and accompanying drawings.

### BRIEF DESCRIPTION OF THE DRAWINGS

FIG. 1 is a schematic illustration of a room including motion sensors;

FIG. 2 is a schematic illustration of a large building including motion sensors and RF control according to the invention;

FIG. 3 is a schematic illustration of a parking lot including motion sensors and RF control according to the invention;

FIGS. 4a-4e schematically illustrate the operation of a construction of the present invention;

FIG. 5 is a schematic illustration of a light including a motion detector and an RF transceiver; and

FIG. 6 is a flowchart illustrating one possible operating mode of a lighting system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

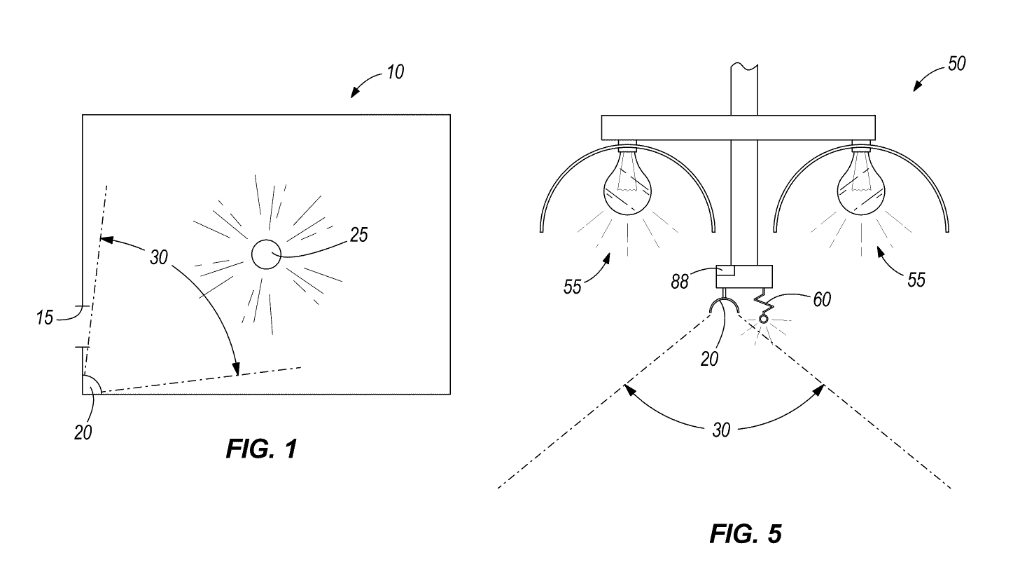

FIG. 1 schematically illustrates a room 10 or building that includes motion control. The room 10 includes a door 15 that provides for entry into the room 10 and exit therefrom. A motion detector 20 is positioned in a first corner of the room 10 and is oriented to detect motion at or near the door 15. The motion sensor 20 could be used to detect the entry of a person into the room 10 to actuate a light 25 or other device in response to that entry. In other arrangements, the motion sensor 20 could be positioned at another location within the room 10. The position of the motion sensor 20 is selected based on the type of sensor 20 used and the range or field of view 30 of that sensor 20.

Motion sensors 20 suitable for use in the arrangement of FIG. 1 include motion sensors 20 that detect motion using infrared (IR), ultrasonic, electric eye, vision systems and the like. As one of ordinary skill in the art will realized many different motion or presence detection devices are available and are suitable for use in the illustrated arrangement. The selection of the particular motion sensor 20 is largely dependent on the type of motion to be detected, the field of view 30 of required of the detector 20, and the accuracy with which that detection must be made. For example, an electric eye arrangement is well suited to detecting the entry of a person into the room 10. However, if the motion sensor 20 is being used to trigger an alarm indicative of unauthorized entry, an electric eye may not be the appropriate choice as one can easily avoid the field of view of an electric eye. In this situation, an IR or ultrasonic system might be more appropriate.

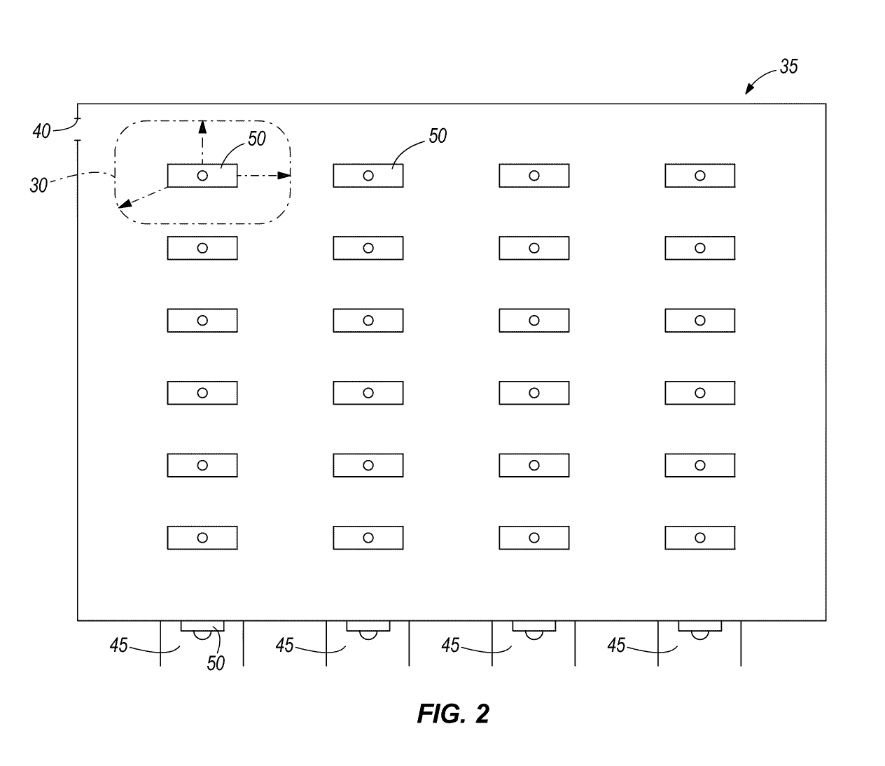

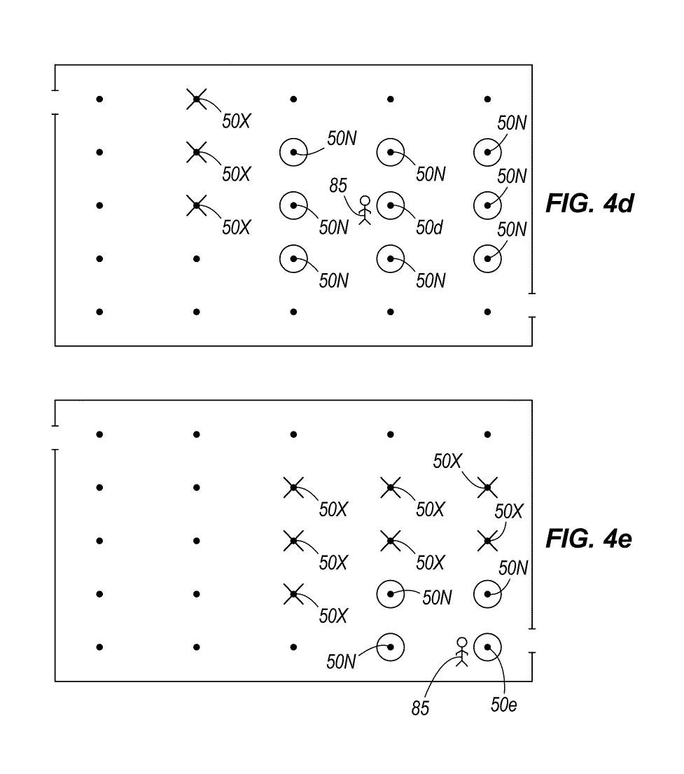

FIG. 2 illustrates another application that is well-suited to the use of motion detection. FIG. 2 illustrates a portion of a building 35 or floor that could operate as a warehouse, storage facility or distribution center. The building 35 includes a main entrance 40 or door through which a person may enter the building 35. The illustrated building 35 also includes a plurality of larger doors that could be used as loading bays 45 to provide for the removal or the delivery of goods into the building 35. Light assemblies 50, such as the one illustrated in FIG. 5 are positioned within the building 35 in an array to properly and efficiently illuminate the building 35 or system area. However, because of the size of the building 35 and the cost of lighting, it is desirable to control the light assemblies 50 using motion detectors 20 (FIG. 5). Thus, each light assembly 50 or group of lights 50 includes a light or lamp 55 and a motion detector 20 having a field of view 30 (device area) sufficient to detect the entry of a person and operable to turn on the lamp 55 nearest the door 40 to illuminate a portion of the building 35.

As the person walks or moves through the building 35, other motion detectors 20 detect motion and turn on the lamps 55 to illuminate the area where the person is located. In some applications, the person can move through the building 35 at a speed that exceeds the speed at which the motion can be detected and the lamps 55 activated. This occurs in situations where the range of the detector 20 is small, the lamps 55 require time to come to full illumination, or the person moves through the building 35 at a relatively high rate of speed (e.g., walking fast, running, riding in a vehicle, etc.).

With reference to FIG. 2 and FIG. 5, each of the lights 50 or groups of lights also includes a radio frequency (RF) transceiver 60. The RF transceiver 60 includes a transmitter portion and a receiver portion such that each is able to transmit radio signals and to receive radio signals. The term “transceiver”, as used herein simply requires that each light assembly 50 include a device that can transmit a signal and a device that can receive a signal. This could be a single device or two separate and distinct devices. In the illustrated construction, when the motion detector 20 detects motion, it activates the lamps 55 and it signals the RF transceiver 60 to broadcast a radio signal at a pre-selected power level. Any RF transceiver 60 within range of the broadcast signal receives the signal and actuates the lamps 55 in response to the signal. Thus, the system of FIG. 2 turns on the lamps 55 in the area where motion is detected as well as in an area surrounding the location of motion. The size of the area is carefully controlled by pre-selecting the range or power level of each transceiver 60. Lamps 55 that turn on in response to the receipt of the broadcast signal do not broadcast a signal to actuate additional lights. Rather, the broadcast is controlled in response to the detection of motion. Thus, the arrangement of FIG. 2 activates the lamps 55 in the area of the person using motion detection and also activates lamps 55 in a bubble around that motion such that the lamps 55 are activated prior to the entry of the person into a particular area.

As illustrated in FIG. 2, the same system enhances the use of the particular loading bays 45. As a vehicle pulls into the bay 45, a motion detector 20 adjacent an outside light 50 detects the arriving vehicle and actuates the outside lamps 55. An RF transceiver 60 broadcasts an RF signal from the bay 45 to turn on the lamps 55 in the immediate area around the loading bay 45. In one construction, a timer is associated with the loading bay 45 to delay the broadcast of the RF signal to provide the driver of the vehicle time to park the vehicle before the interior lamps 55 are activated, thereby further enhancing the energy efficiency of the system.

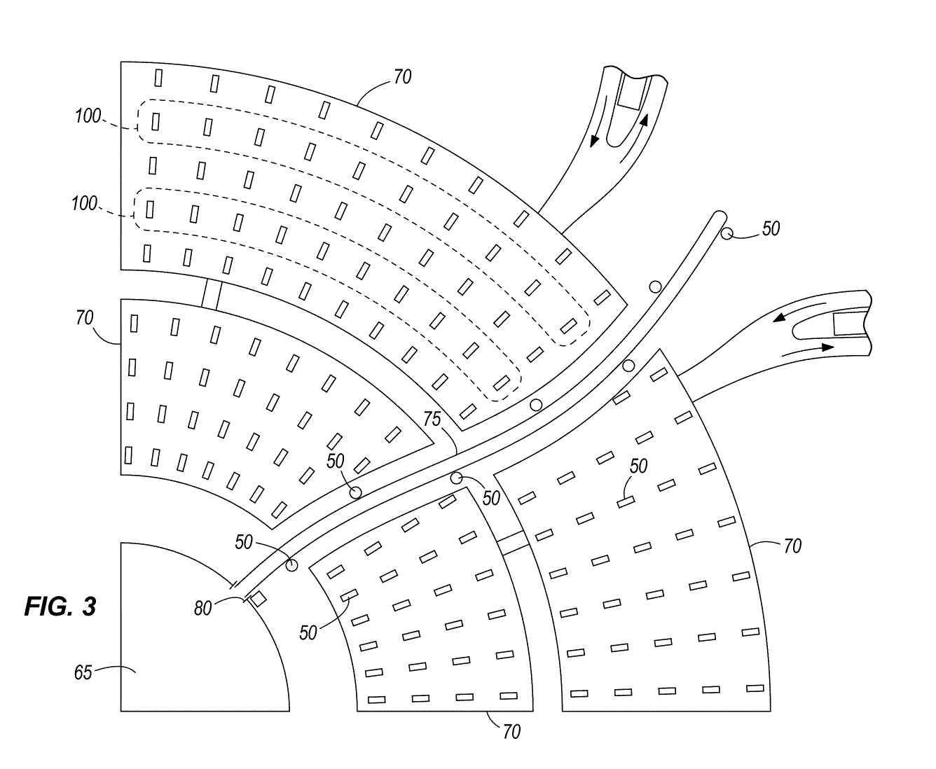

FIG. 3 illustrates another application of the system of FIG. 2. The construction of FIG. 3 includes a building 65 that may be an office building, a mall, or other place of business. A number of parking lots 70 are positioned around the building 65 and a walkway 75 is positioned to provide a path 75 for the people to follow between the parking lots 70 and an entrance 80 of the building 65.

Path lights 50 are positioned along the path 75 to illuminate the path 75. Each of the lights 50 includes a lamp 55, a motion sensor 20, and an RF transceiver 60 as illustrated in FIG. 5. When a person enters the path 75, one of the motion detectors 20 detects the person and turns on the lamp 55 associated with that motion sensor 20. The RF transceiver 60 associated with that lamp 55 broadcasts a signal that is received by any RF transceiver 60 within a desired range. The transceivers 60 that receive the signal activate the lamp 55 with which they are associated to turn on the lamps 55 around the light 50 at which the motion is detected. In preferred arrangements, the range of the RF transceiver 60 is selected to turn on the fewest number of lamps 55 possible while completely illuminating the path 75 of the person. For example, in one construction, the range is selected such that two adjacent lamps 55 in each direction from the light 50 at which motion is detected are activated.

Each of the parking lots 70 includes a number of lights 50 with each light 50 or group of lights including a lamp 55, a motion sensor 20, and an RF transceiver 60. The parking lot lights 50 work in a manner similar to the lights 50 described with regard to FIG. 2. Because the motion being detected in the parking lot 70 is the motion of a vehicle and is likely faster than the motion of a walking person, it is possible that more lights 50 need to be activated in response to movement to assure that the lights 50 are on ahead of the arrival of the vehicle. To assure this, the transmission range of each RF transceiver 60 could be increased.

In another application, the system is applied to a multi-level parking ramp. As with the other arrangements, the lights 50 within the ramp detect movement of the vehicle within the ramp and actuate a light 50 or group of lights in response to that motion. In addition, an RF transceiver 60 associated with the motion detector 20 that detected the motion broadcasts a signal that is received by other RF transceivers 60 associated with nearby lights 50. The RF transceivers 60 that receive the signals then actuate their associated lamps 55 to light an area around the moving vehicle.

In some constructions, the RF transceivers 60 analyze the order and the speed at which RF signals are received and use that data to actuate only the desired lamps 55. For example, if a vehicle is exiting a parking ramp, the RF transceivers 60 would continually receive signals from RF transceivers 60 at higher levels or from positions further from the exit. The system could detect this and inhibit the activation of lamps 55 in directions that do not lead toward an exit, thereby leading the vehicle toward the exit.

In each of the constructions discussed herein, each light 50 may include a timer 88 (shown in FIG. 5) or other device that measures or calculates the passage of time. Each light 50 could be set to turn off after a fixed passage of time after activation. For example, one construction turns the lights 50 off five minutes after they are activated. If, within that five minute period the motion detector 20 associated with the light 50 detects motion or the RF transceiver 60 receives a signal, the time index for that light 50 would reset. In still other constructions, the detection of an additional signal or the detection of motion would increase the timer 88 by a fixed amount and may or may not reset the time index. For example, if after two minutes a particular light 50 detects motion, the time index could be reset to zero and the timer 88 restarts the five minute countdown. Alternatively, the time index could reset and the timer 88 could restart after adding five minutes to the on time of the light. Thus, the timer 88 would shut off the light after 10 minutes. In still another example, additional time is added to the operating time but the time index is not reset. Thus, in the foregoing example, the light 50 would have three minutes left from the initial five minutes of allotted time plus an additional five minutes until the light 55 is powered down.

In constructions that extend the length of time the light 55 remains on, there would generally be a maximum limit to assure that eventually the light 55 turns off. In addition, while a time of five minutes is described herein, many different time increments could be employed. In addition, the time increments can vary from light 50 to light 50 if desired. In addition, when one light 50 detects motion that resets the time limit for that light, the RF transceiver 60 for that light could broadcast a signal that resets the time limit for any lights 50 within range of the RF transceiver 60.

Thus, as illustrated in FIG. 5, each preferred light assembly 50 includes a lamp or light 55, a motion detector 20, a transceiver 60, and a timer 88 associated with one another.

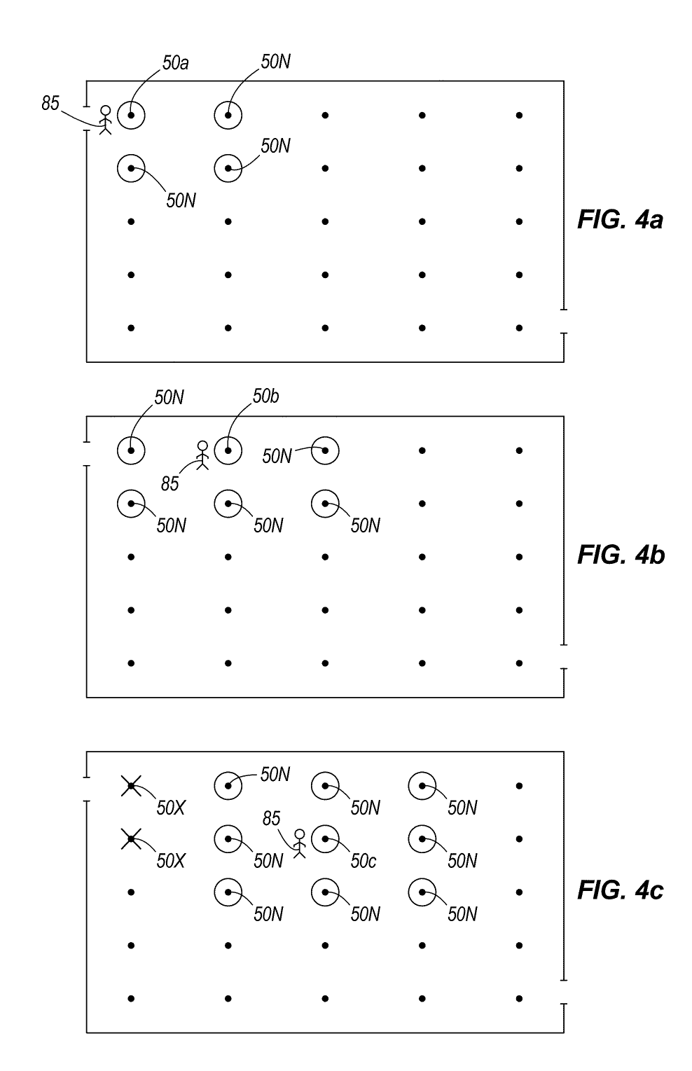

FIGS. 4a-4e illustrate the operation of one possible arrangement of a system similar to that described with regard to FIGS. 1-3 where the dots represent a light assembly 50. As illustrated in FIG. 4a, as a person 85 enters the system, the first motion detector 20 at a first light 50a detects motion and actuates the light or lights with which the detector 20 is associated. In addition, the RF transceiver 60 transmits a signal that is received by the lights 50n located within the transmission range. In the illustrated construction, the three adjacent lights 50n are within that range and as such only these lights 50n are activated. Thus, the circled lights 50n are activated.

As the person 85 traverses the space, additional detectors 20 detect the motion, activate their respective lights 50b, 50c, 50d, and transmit signals to activate additional lights 50n in range of the signal. As illustrated in FIG. 4c, two the lights 50x that were activated are now outside of the range of the transmission and as such begin the timeout process and eventually deactivate. The lights 50x that are timing out or deactivating are shown X′ed out.

As illustrated in FIG. 4e, the arrival of the person 85 at the light 50e activates only four lights 50n with seven previously activated lights 50x switching from a “currently activated” state to a “time out” state. Additional lights 50 may be timing out as well, however, only the illustrated lights 50x switch states upon the arrival of the person 85 at light 50e.

A major advantage to this design is that the system is very easy to setup and implement. There is no need for a central computer to coordinate the system. The lights 50 as described herein adapt to the environment without a host.

Although the Federal Communications Commission (FCC) limits the range that an RF signal can be sent, this can be an advantage. By limiting the range that each RF transceiver 60 will transmit, the range around the device 50 that detected motion activates other devices 50 is controlled to assure that on more device 50 than are needed are activated.

It should be noted that the invention has been described in terms of systems that activates lights 50. However, the system could activate many other devices in addition to or in place of lights 50. For example, one construction activates speakers to broadcast sound in only the areas occupied by people. Still other constructions activate the motion detectors 20 in conjunction with the lamps 55, speakers or other components.

In one construction only one motion detector 20 is maintained in an active state. This motion detector 20 is nearest the door or entrance to a particular area. Upon detection of motion, the motion detector 20 activates the lights 55 in the immediate area and triggers the broadcast of the RF signal. Any transceiver 60 that receives the RF signal activates the lamps 55 and also activates the associated motion detector 20 to allow for the detection of motion. This arrangement reduces the likelihood of false or undesired activations as none of the lights 50 can be powered until the motion detector 20 nearest the door detects motion. Of course, the first motion detector 20 could be replaced with a card reader or other security device used to control access to a room or building if desired.

In some constructions, each of the light assemblies 50 is assigned to one or more groups. The groups 100 are arranged such that a signal transmitted from one of the light assemblies 50 can only activate lights that are in the same group 100. This arrangement is particularly useful for systems in which there are multiple rows of light assemblies 50 with each row being its own group 100. For example, in some warehouses, products are stored on multiple rows of shelves. If a user or vehicle enters one of the rows, the first light assembly 50 detects the motion, turns the light on and transmits a signal. All of the lights in the particular row receive the signal and are also activated. In addition, the light assemblies 50 in adjacent rows receive the signal. However, these lights are not activated as they are not in the same group 100 as the transmitting light assembly 50. Thus, only the lights in the particular row are activated. If the user or vehicle moves from one row to another, the light assembly 50 in the second row will detect the motion, activate, and transmit a signal that will activate only the second group 100 of light assemblies 50.

To further enhance the energy-saving features of the just-described construction, the light assemblies 50 can be programmed to initially activate at a partial power level. In this construction, the first light assembly 50 detects motion, transmits a signal, and activates the light at a partial power level (e.g., ½ power). The signal is received by light assemblies 50 in the same group 100 and in different groups 100 with the light assemblies 50 in the same group 100 activating their lights at a reduced power level. The light assemblies 50 then monitor the motion in their particular field of view and if that activity reaches a predetermined level, the light assembly 50 increases the power level of the light to its full power or its desired power level. For example, one arrangement may include rows of shelves that include product. As a fork truck traverses a row, the light assemblies 50 are activated at half-power. This provides enough light to quickly traverse the row. However, when the fork truck pauses to get a product from the shelf, the light assembly 50 in that area detects the pause and immediately increases the illumination level to full power.

In yet another example, a factory includes multiple groups 100 of light assemblies 50. As the factory begins work, light assemblies 50 within the various groups 100 detect motion, transmit signals, and activate the lights at half power or some reduced power level. The signals initially transmitted instruct the light assemblies in each group 100 to operate at reduced power. Each of the light assemblies 50 monitors the motion within its field of view. If the level of motion exceeds a predetermined level, the light assembly 50 transitions to full power and transmits a signal that indicates that the other light assemblies 50 should switch to full power, with the lights in the same group switching in response to receipt of the signal. For example, the light assemblies 50 may operate at reduced power until the motion detector 20 detects at least three separate moving bodies in the field of view. Once three or more moving bodies are detected, the light assembly 50 transitions to full power. As people begin leaving the factory, the level of motion declines. Once a light assembly 50 detects motion by fewer than three moving bodies, a timer begins. Once the timer reaches a predetermined time limit, the light assembly 50 transitions to reduced power. Once no motion is detected, the light assembly 50 can be quickly transitioned to a deactivated state. As one of ordinary skill in the art will realize, this system can greatly reduce the power consumption for the light assemblies 50 within the factory.

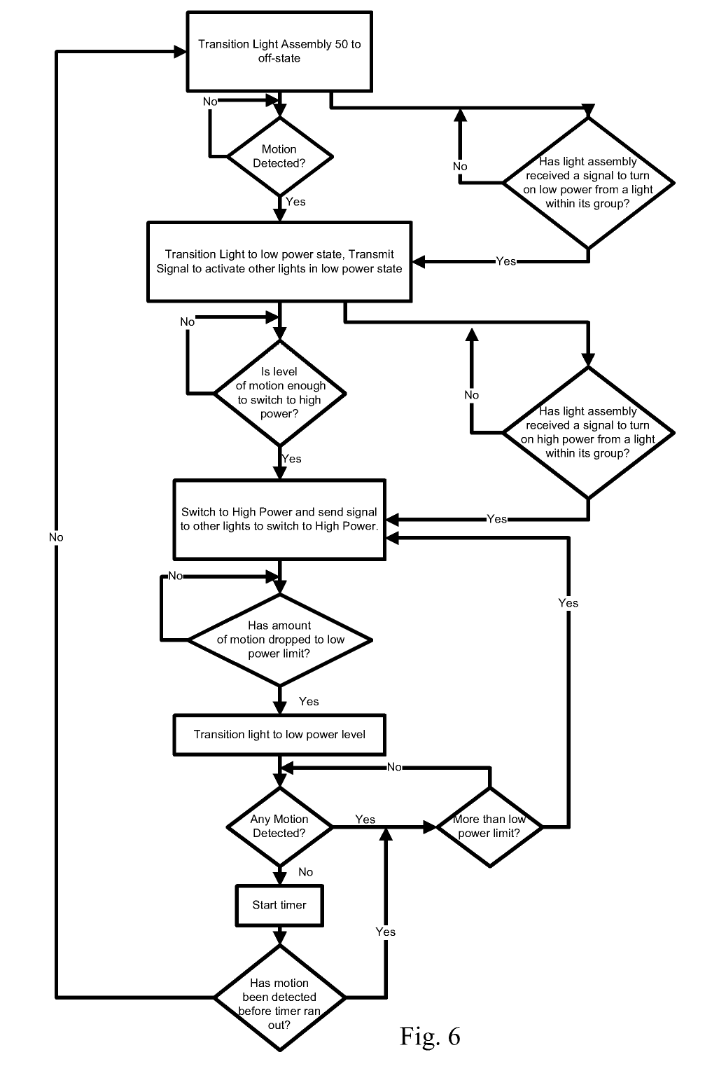

FIG. 6 illustrates one operating mode for a lighting system. As illustrated in FIG. 6, the light assemblies 50 of one or more groups 100 of light assemblies 50 are in the off state or in a minimal power state. Each light assembly 50 continuously or periodically listens for a signal from other light assembly 50 and monitors a filed of view for any motion. If the light assembly 50 detects a signal from another light assembly 50, and that light assembly 50 is in the same group as the light assembly 50 that detects the signal, the light assembly 50 will transition its light or lights to a low power state. If the light assembly 50 detects motion in its motion sensor's field of view, the light assembly will also transition to a low power state. The light assembly 50 may also broadcast a signal to other light assemblies 50 in its range. In preferred constructions, the signal includes information regarding the group that the light assembly 50 originating the signal is a part of and the power level to which the receiving lights should power up to. The information can be contained or coded in any suitable manner.

Once the light assembly 50 is operating in the low power state, the light assembly 50 continues to listen for a signal that might indicate that the light assembly 50 should transition to a full power level and continues to monitor its field of view for motion. The motion detector 20 and light assembly 50 monitor for a quantity of motion that exceeds a predetermined level of motion. If that level of motion is detected, the light assembly 50 transitions to the high power level and broadcasts a signal that includes the group information and instructions to transition to a full power level. Similarly, if the light assembly 50 receives a signal from another light assembly 50 within its group that indicates the light assembly 50 should transition to full power, the light assembly 50 will so transition. Each light assembly 50 that is operating at full power will continue to monitor its field of view for motion. If the level of motion drops below the predetermined level of motion for a predetermined period of time, the light assembly 50 will transition to the low power level. The light assembly 50 will continue to monitor its field of view for motion when in the low power level. If no motion is detected for a predetermined period of time, the light assembly 50 will transition to the off state.

It should be noted that the motion detectors are capable of detecting motion from virtually any source. Thus, the sensors are generally tailored to detect the particular type of motion that is expected. For example, some systems may be arranged to detect the motion of a person walking or running through a facility. In another construction, the motion detectors are arranged to detect the motion of a larger object such as a fork lift or other small vehicle that moves through a facility. In still other constructions, the motion detector detects the movement of larger vehicles such as automobiles or trucks. Of course combinations or variations of these examples are also possible.

Thus, the invention provides, among other things, an RF controlled system that is enhanced through the use of motion sensors. Various features and advantages of the invention are set forth in the following claims.

What is claimed is:

1. A system comprising:
a plurality of electrical components arranged in an array to cover a system area, each of the electrical components spaced apart from each of the remaining electrical components and operable in a first state and a second state;
a plurality of motion sensors, each motion sensor positioned adjacent one of the electrical components and operable to detect motion within a device area, the device areas cooperating to cover at least the system area; and
a plurality of transceivers, each transceiver positioned adjacent one of the electrical components and operable to receive a signal from a first portion of the plurality of transceivers and to transmit a signal to a second portion of the plurality of transceivers, wherein each motion sensor transitions its corresponding electrical component to the second state and activates its corresponding transceiver to transmit a signal in response to the detection of motion within its device area, and wherein each transceiver transitions its corresponding electrical component to the second state in response to the receipt of the signal.

2. The system of claim 1, wherein the electrical components are lights, each operable to illuminate a portion of the system area.

3. The system of claim 1, wherein the device area is smaller that the system area.

4. The system of claim 1, wherein the first portion of transceivers includes fewer transceivers than the plurality of transceivers.

5. The system of claim 1, wherein the second portion of transceivers includes fewer transceivers than the plurality of transceivers.

6. The system of claim 1, further comprising a plurality of timers, each timer associated with one of the plurality of electrical components and operable to transition the electrical component from the second state to the first state in response to the passage of a predetermined time period.

7. The system of claim 6, wherein the timer begins timing the time period after the latest of receipt of a signal by the transceiver associated with the timer and the detection of motion by the motion detector associated with the timer.

8. The system of claim 1, wherein the motion sensor transitions the electrical component to a third state in response to the detection of a quantity of motion that is less than a predefined level and transitions the electrical component to the second state when the quantity of motion exceeds the predefined level, wherein the third state is a lower power state than the second state.

9. The system of claim 1, wherein the plurality of transceivers are divided into a plurality of groups with each group including at least one transceiver and wherein each transceiver transitions its corresponding electrical component to the second state in response to the receipt of the signal only when the signal is transmitted by another transceiver that is in the same group.

10. A method of transitioning select electrical components from a plurality of electrical components in a system area from an off state to an on state, the method comprising:
positioning a motion sensor adjacent each of the plurality of electrical components, each motion sensor operable to detect motion within a device area;
positioning a transceiver adjacent each of the plurality of electrical components and motion sensors, each transceiver operable to receive a signal from a portion of the transceivers and to transmit a signal to a portion of the transceivers;
detecting motion within the device area of a first of the motion sensors;
transitioning a first of the plurality of electrical component associated with the first motion sensor from the off state in response to the detected motion;
broadcasting a signal from a first transceiver associated with the first motion sensor;
receiving the signal at a second of the plurality of transceivers, the second transceiver spaced a first distance from the first transceiver; and
transitioning a second electrical component associated with the second transceiver from the off state in response to receipt of the broadcast signal.

11. The method of claim 10, wherein each of the electrical components includes a light that is operable in the on state to illuminate an illumination area.

12. The method of claim 10, wherein the broadcasting step includes broadcasting the signal at a first power level selected such that the signal is receivable by transceivers in an area that is smaller than the system area.

13. The method of claim 10, further comprising positioning a timer adjacent each of the plurality of electrical components, the timer operable to time the passage of a predetermined length of time.

14. The method of claim 13, further comprising initiating operation of the timer in response to each of the detection of motion by the motion detector associated with the timer and the receipt of a signal by the transceiver associated with the timer.

15. The method of claim 14, further comprising transitioning the electrical component to the off state in response to the timer associated with electrical component indicating that the predetermined length of time has passed since the last initiation.

16. The method of claim 10, further comprising detecting the quantity of motion within the device area of the first of the motion sensors and transitioning the first electrical component to a partial power state in response to the detection of a quantity of motion that is less than a predefined level and transitioning the first electrical component to the on state when the quantity of motion exceeds the predefined level.

17. A method of operating a plurality of light assemblies to illuminate a system area, each of the light assemblies including a light, a timer, a motion detector, and a transceiver, the method comprising:
positioning a first light assembly in the system area, the first light assembly including a first light, a first timer, a first motion detector, and a first transceiver;
positioning a second light assembly in the system area, the second light assembly spaced a first distance from the first light assembly and including a second light, a second timer, a second motion detector, and a second transceiver;
positioning a third light assembly in the system area, the third light assembly spaced a second distance from the first light assembly, the second distance being greater than the first distance, the third light assembly including a third light, a third timer, a third motion detector, and a third transceiver;
detecting motion with the first motion detector;
energizing the first light in response to the detection of motion;
broadcasting a signal at a predetermined strength in response to the detection of motion, the strength selected such that the signal can be detected by a transceiver spaced the first distance from the first light assembly and cannot be detected by a transceiver spaced a distance greater than the first distance from the first light assembly;
receiving the signal at the second transceiver; and
energizing the second light in response to the receipt of the first signal.

18. The method of claim 17, further comprising initiating operation of the first timer in response to the detection of motion.

19. The method of claim 18, further comprising initiating operation of the second timer in response to the receipt of the signal.

20. The method of claim 18, further comprising de-energizing the first light in response to the first timer indicating that a predetermined time period has passed.

21. The method of claim 17, further comprising detecting motion at the second motion detector subsequent to detecting motion at the first motion detector.

22. The method of claim 21, further comprising maintaining the second light in the energized state and broadcasting a second signal from the second transceiver in response to the detected motion at the second motion sensor.

23. The method of claim 22, further comprising receiving the second signal at the first transceiver and the third transceiver and energizing the third light and maintaining the first light in the energized state in response to the receipt of the second signal.

24. The method of claim 17, further comprising detecting a quantity of motion with the first motion detector and transitioning the first light to a partial power state in response to the detection of a quantity of motion that is less than a predefined level and transitioning the first electrical component to a full power state when the quantity of motion exceeds the predefined level.

25. A system comprising:
a first light assembly including a first light, a first motion sensor, and a first transceiver;
a second light assembly including a second light, a second motion sensor, and a second transceiver, the second light assembly positioned a first distance from the first light assembly; and
a third light assembly including a third light, a third motion sensor, and a third transceiver, the third light assembly positioned a second distance from the first light assembly, the second distance being greater than the first distance, wherein the first light is transitioned to an on condition and the first transceiver broadcasts a signal in response to the first motion detector detecting motion, and wherein the second transceiver receives the signal and activates the second light in response to the signal and the third transceiver does not receive the signal.

26. The system of claim 1, wherein the first motion sensor detects a quantity of motion in a filed of view, and wherein the first motion sensor transitions the first light from an off state to a partial power state in response to the detection of a quantity of motion that is less than a predefined level and transitions the electrical component to a full power state when the quantity of motion exceeds the predefined level.
